(19) United States
(12) Patent Application Publication
(10) Pub. No.: US 2013/0097305 A1
(43) Pub. Date: Apr. 18, 2013

(54) Bearer Management And Metrics Gateway

(71) Applicant: Nandakishore A. Albal, Scottsdale, AZ (US)

(72) Inventor: Nandakishore A. Albal, Scottsdale, AZ (US)

(73) Assignee: Nokia Siemens Networks Oy

(21) Appl. No.: 13/275,523

(22) Filed: Oct. 18, 2011

(51) Int. Cl. G06F 15/173

(52) U.S. Cl. 709/224

(57) ABSTRACT

In accordance with the exemplary embodiments of the invention there is at least a method, apparatus to perform operations including collecting metrics from one or more network devices of the wireless communication network, and using the collected metrics to enable one of establishment and modification of a Bearer in the wireless communication network to provision a service in accordance with specified characteristics.

### TECHNICAL FIELD

The teachings in accordance with the exemplary embodiments of this invention relate generally to providing differentiated services for a subscriber and, more specifically, relate to providing differentiated services for large files downloaded or streamed by the subscriber in a wireless network which is using a service entity, such as a media optimizer and video servers.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Service providers and operators have been providing increasingly complex services to their subscribers. As time goes by, more and more of these services involve downloading or streaming large files, such as video files. Furthermore, subscribers are expecting that service providers and/or operators provide for these types of downloads more quickly and efficiently than ever before, even over wireless networks.

However, the service providers and operators do not yet have a mechanism to provide a differentiated service for such large file downloads. Currently, larger file downloads such as for video files and downstream video are simply sent with the best effort. Therefore, a need exists to provide differentiated services for such downloads, for example downstream video file downloads.

Certain abbreviations that may be found in the description and/or in the Figures are herewith defined as follows:

AUC authentication center

### AVP Attribute-Value Pair

### BM-SC Broadcast Multicast Service Center (3GPP)

### CAN Content Aware Network

CAN-EG content aware network enabling gateway
DTCH dedicated traffic channel
E-UTRAN evolved UTRAN
ECGI E-UTRAN cell global identifier
EPS evolved packet system
FR feature request
GGSN gateway GPRS support node
GMLC gateway mobile location center
GPRS general packet radio services
GTP-u GPRS Tunneling Protocol-User plane
GTP-c GPRS Tunneling Protocol-Control plane
IP-CAN Internet Protocol connectivity access network
LTE long term evolution network
MBMS multimedia broadcast/multicast service (3GPP)
MBMS-GW multimedia broadcast/multicast service gateway
MCC mobile country code
MCN mobile network code
MIB mobile internet browser
MME mobility management entity
MNO mobile network operator
MO mobile operator
NE network element
OAM&P operations, administration, maintenance, and provisioning
PCRF policy server
PSAP public safety access points
RAN remote access network
RAT radio access technology
SCTP stream control transmission protocol
SLA service level agreement
UE user equipment
UTRAN universal terrestrial radio access network

### WIMAX Worldwide Interoperability for Microwave Access

### SUMMARY

In an exemplary aspect of the invention, there is method, comprising collecting metrics from one or more network devices of the wireless communication network, and using the collected metrics to enable establishment of a Bearer in the wireless communication network to provision a service in accordance with specified characteristics.

In another exemplary aspect of the invention, there is an apparatus comprising at least one processor, and at least one memory including computer program code, where the at least one memory and the computer program code are configured, with the at least one processor, to cause the apparatus to at least collect metrics from one or more network devices of the wireless communication network, and use the collected metrics to enable establishment of a Bearer in the wireless communication network to provision a service in accordance with specified characteristics.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates a conventional optimizer interface to a network;

FIG. 2 illustrates a simplified block diagram of exemplary electronic devices that are suitable for use in practicing various exemplary embodiments of this invention;

FIG. 3 illustrates CAN-EG communication architecture in accordance with the exemplary embodiments of the invention;

FIG. 4A illustrates another CAN-EG communication architecture in accordance with the exemplary embodiments of the invention;

FIG. 4B illustrates another CAN-EG communication architecture for use with applications and services, as in accordance with the exemplary embodiments of the invention

FIG. 5 illustrates a communication flow of a service request for unicast Bearer establishment with a specified QoS;

FIG. 6 illustrates a unicast Bearer modification request in accordance with the exemplary embodiments of the invention;

FIG. 7 illustrates an operation in accordance with the exemplary embodiments of the invention of reporting of metrics to the services and action by the service entity;

FIG. 8 illustrates an operation, in accordance with the exemplary embodiments, of a channel termination in response to a request by a service entity;

FIG. 9 illustrates another exemplary embodiment of the invention comprising a channel termination request performed by the CAN-EG;

FIG. 10 illustrates exemplary operations of the CAN-EG used for call/session establishment based on video parameters and UE information;

FIG. 11 illustrates exemplary operations of the CAN-EG used for a mid-call modification based on UE information, such as via the MME or eNodeB or a ZenB controller;

FIG. 12 illustrates a service request to the CAN-EG for a MBMS with a specified QoS; and

FIG. 13 is a simplified block diagram to illustrate a method in accordance with the exemplary embodiments of the invention.

### DETAILED DESCRIPTION

The exemplary embodiments of the invention relate to a method to provide differentiated services for the subscriber who downloads or streams large files. More particularly, the exemplary embodiments of the invention relate to a method to provide differentiated services for files downloaded using a service entity such as a media optimizer.

One example of a technology which has been used to attempt to address expectations, such as described above, includes Over the Top (OTT) services. OTT services provide a peer-to-peer download functionality which can be used to increase download speeds. Another example of a relevant technology involves third party media optimizers (MOs) for such downloading.

The video/media optimizers or service entities operate using feedback, such as from the UE 18. It is this feedback that the optimizers use to dynamically modify the video stream such as to reduce the file size, transrate or transcode the content which subsequently reduces the required bandwidth for a transmission and improves the overall quality of experience of the end-user. To the network, the optimizer appears as an application server and operates independent of the network that the UE is connected to.

The optimizers presently work on 3G networks and are expected to be used extensively in LTE or 4G networks.

An exemplary embodiment of the invention would benefit at least third party video optimizers by providing indicators based on network conditions for use by the optimizers, such as for modification of a Bearer. The indicators provided to the optimizer will allow the optimizer to make additional modifications to a video stream which were not previously possible and thus greatly improve performance of video downloads.

Further, in accordance with the exemplary embodiments of the invention, a service entity and/or optimizer would benefit as it would be able to request a modification of a session and/or Bearer. For example, at the start of a video stream the optimizer could indicate a type of channel that is required for a particular video download. Additionally, in accordance with the exemplary embodiments, during the life of a session, such as a download session, an optimizer could indicate required channel conditions, such as based on video parameters, to the network that would enable the network to modify a channel dynamically, even mid-session, for a standing SLA, improved performance and/or a change of a Bearer, to name but a few benefits.

The term Bearer may be defined to be an aggregate of one or more communication flows such as related to one or more services in a network, such as an LTE network. Types of Bearers for which the exemplary embodiments of the invention can be applied may include, but are not limited to, EPS Bearers. An EPS Bearer exists between a mobile node and a gateway, such as a UE and a PDN-GW, respectively, and is used to provide the same level of packet forwarding treatment to the aggregated IP flows constituting the Bearer. It is noted that services with IP flows requiring a different packet forwarding treatment would therefore require more than one EPS Bearer.

Bearers, in accordance with the exemplary embodiments of the invention, may be using IP and/or non-IP protocols, such as for gateways to non-IP networks. Further, in accordance with the exemplary embodiments, Bearers using IP protocols may be using IPv4 and/or IPv6 addressing schemes. Additionally, the protocols may or may not be connection oriented protocols.

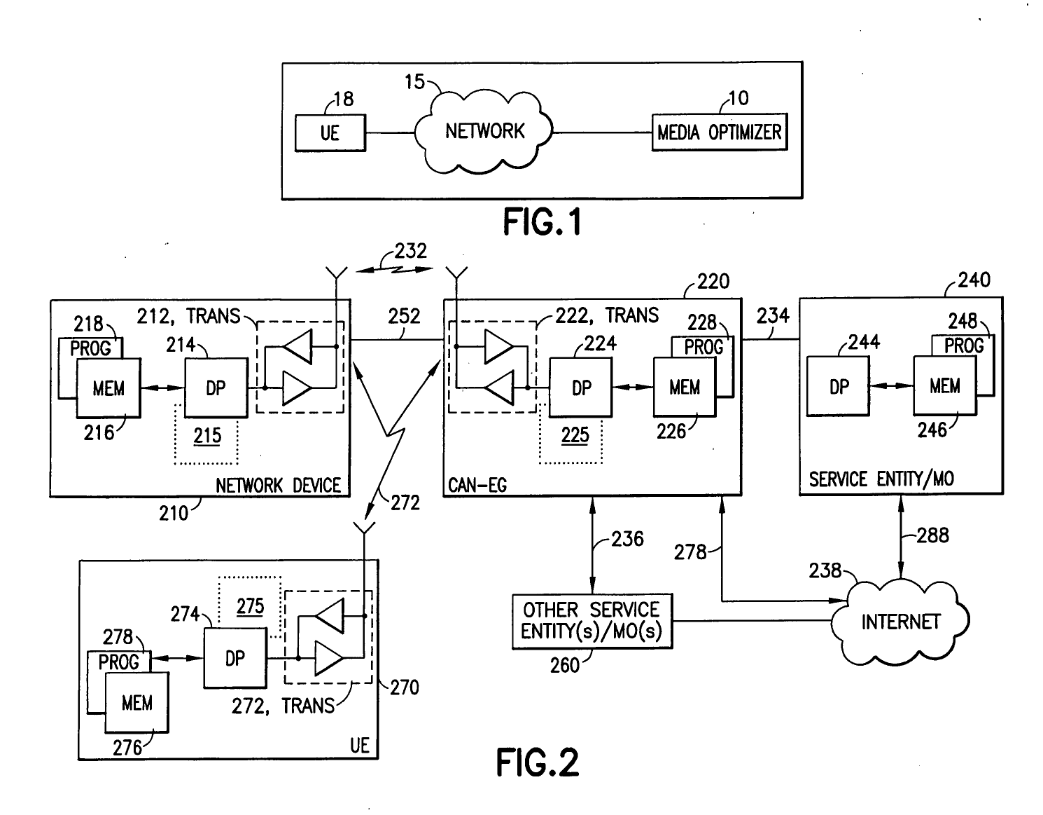

FIG. 1 illustrates a conventional media optimizer interface to a network. As illustrated in FIG. 1 a media optimizer 10 is connected to a network 15 and a UE 18 is also connected to the network 15. The media optimizer 10 is operating independent of the network in a fashion similar to the “over the top” devices, as previously described. The UE and the optimizer can be seen to be operating in a peer-to-peer manner, and the media optimizer 10 is unaware of any network conditions which would affect a download by the UE 18. It is noted that at least the method in accordance with the exemplary embodiments of the invention may be used to the benefit of a wide range of service entities of which a media optimizer is only one type of service entity.

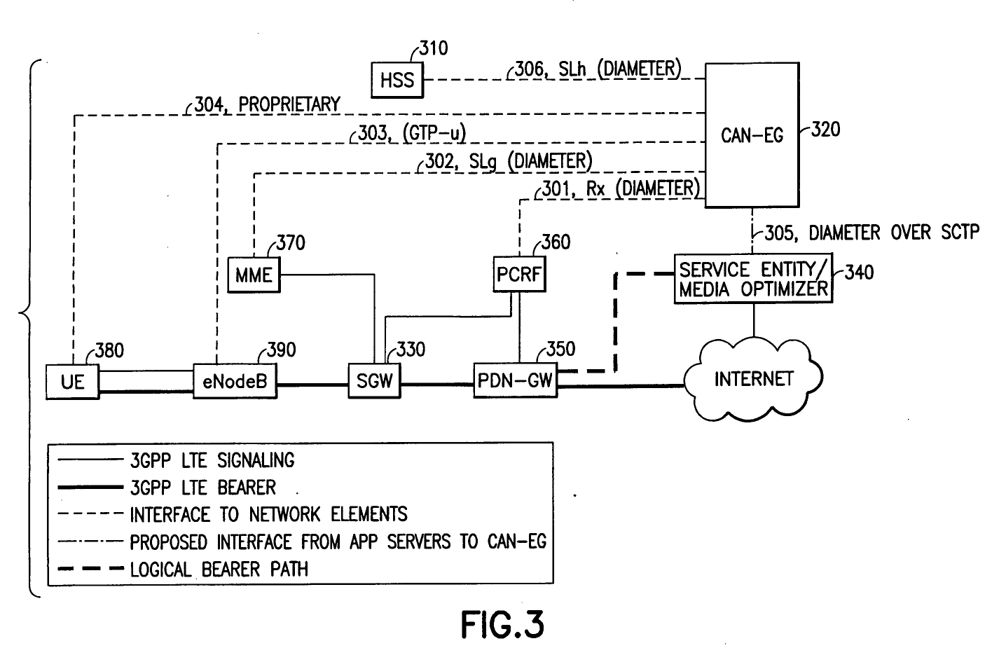

Before describing in further detail various exemplary embodiments of the invention, reference is made to FIG. 2 for illustrating a simplified block diagram of various electronic devices and apparatus that are suitable for use in practicing the exemplary embodiments of this invention.

In FIG. 2, in accordance with the exemplary embodiments of the invention, a CAN-EG 220 is communicating with network devices and/or user equipment, such network device 210 and a mobile communication device herein identified as UE 270. It is noted that, though not illustrated, communications between the CAN-EG and the Network Node 210 and/or the UE 270 can be via a network access node, such as a NodeB or eNodeB (base station). Further, in accordance with the exemplary embodiments of the invention, the CAN-EG can be coupled to the network device 210 via a wireless communication link 232 and/or a wired communication link 252, or a combination of a wireless and wired communication link. The CAN-EG may communicate with the UE 270 via the wireless communication link 272 or through another network device. Any of these communications can use an interface as described below, in accordance with the exemplary embodiments of the invention. In addition, the CAN-EG may or may not be part of the wireless network 235 where the network device 210 and/or the UE 270 may reside or be associated. For example, the CAN-EG can be outside a radio access network and/or outside a radio operator's network. Conversely, the CAN-EG can be inside, or part of, a radio access network or a radio operator's network. Further, in accordance with the exemplary embodiments of the invention, the functionality of the CAN-EG may be incorporated in any network node associated with the wireless network 235, such as a base station. The wireless network 235 may include or be coupled to a service entity 240 such as a media optimizer. Further, the wireless network 235 may include the CAN-EG 220. The CAN-EG configured to perform operations in accordance with the exemplary embodiments of the invention as described below. In addition, the service entity 240 may or may not be part of the wireless network 235. In accordance with the exemplary embodiments of the invention, the CAN-EG 220 may be coupled with the wireless network 235 and/or the service entity 240 and/or one or more other service entities 260, all or in part, via a connection 278 with a data communications network (e.g., the internet 238). Further, the CAN-EG may be coupled with the wireless network 235 and/or the service entity 240 and/or one or more other service entities 260, all or in part, via different types of hardwire connections 234 and/or 236. Connections of the service entity 240 and the one or more other service entities 260 to the internet 238 are illustrated as connections 288 and 238, respectively.

The UE 270 includes a controller, such as a computer or a data processor (DP) 274, a computer-readable memory medium embodied as a memory (MEM) 276 that stores a program of computer instructions (PROG) 278, and a suitable wireless interface, such as radio frequency (RF) transceiver 272, for bidirectional wireless communications via one or more antennas with the wireless communications network 235.

The CAN-EG 220 also includes a controller, such as a computer or a data processor (DP) 224, at least one computer-readable memory medium embodied as a memory (MEM) 226 that stores at least one program of computer instructions (PROG) 228, and a suitable wireless interface, such as RF transceiver 222, for communication with network devices of the network 235 and with the UE 270 using one or more antennas. The CAN-EG 220 is coupled via a data/control path 234 to the service entity 240. The path 234 may be implemented as a Diameter over SCTP interface and/or with any other interface, such as a SOAP interface as described in further detail below. The CAN-EG 220 may also be coupled to other service entities via a data/control path 236, which may also be implemented as a Diameter over SCTP interface or any other interface.

The service entity 240 includes a controller, such as a computer or a data processor (DP) 244, a computer-readable memory medium embodied as a memory (MEM) 246 that stores a program of computer instructions (PROG) 248.

At least one of the PROGs 218, 228, 248 and 278 is assumed to include program instructions that, when executed by an associated DP, enable the device to operate in accordance with exemplary embodiments of this invention, as will be discussed below in greater detail. That is, various exemplary embodiments of this invention may be implemented at least in part by computer software executable by the DP 274 of the UE 270; by the DP 224 of the CAN-EG 220; by the DP 214 of the network device and/or by the DP 244 of the service entity 20, or by hardware, or by a combination of software and hardware (and firmware) of the devices.

The UE 270, the network device 210 and the CAN-EG 220 may each also include dedicated processors for performing the operations in accordance with the exemplary embodiments. For example, the dedicated processors can include the metric processor 275, metric processor 215 and metric processor 225.

In general, the various embodiments of the UE 270 can include, but are not limited to, cellular telephones, tablets having wireless communication capabilities, personal digital assistants (PDAs) having wireless communication capabilities, portable computers having wireless communication capabilities, image capture devices such as digital cameras having wireless communication capabilities, display devices and components for streaming video capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEMs 216, 226, 246 and 276 may be of any type suitable to the local technical environment and may be implemented using any suitable data storage technology, such as semiconductor based memory devices, flash memory, magnetic memory devices and systems, optical memory devices and systems, fixed memory and removable memory. The DPs 214, 224, 244 and 274 may be of any type suitable to the local technical environment, and may include one or more of general purpose computers, special purpose computers, microprocessors, digital signal processors (DSPs) and processors based on multicore processor architecture, as non-limiting examples. The wireless interface 232 (e.g., RF transceivers 212 and 222) and the wireless interface 272 may be of any type suitable to the local technical environment and may be implemented using any suitable communication technology such as individual transmitters, receivers, transceivers or a combination of such components.

The exemplary embodiments of the invention provide a content aware network enabling gateway (CAN-EG) between the media optimizer device 10, or another device providing download and streaming services, and the UE 18. In accordance with the exemplary embodiments of the invention, the CAN-EG is configurable to:
Interface to network element (NE), or network device(s), to receive network metrics such as, but not limited to, cell/sector metrics, UE metrics, UE location, UE velocity and IPCAN related metrics.
Initiate requests to NEs to establish and/or modify Bearers dynamically
Initiate requests to NEs for specific QoS at the start of a session or anytime during the session
Maintain and record the UE and cell/sector metrics
Provide the received metrics to authorized applications and services based on policy rules configured for the CAN-EG
Provide aggregated metrics to operators and/or service applications to facilitate service level agreement compliance and/or revenue reconciliation
Interpret the metrics and provide the interpretations to the service entities.
Appear to network devices, such as a policy control and charging rules function (PCRF), to be an application server
Act as a trusted agent to the network entities and to the Service Entities
Act on behalf of the service entities to perform the Bearer management based on their request. In accordance with the exemplary embodiments of the invention the CAN-EG can perform operations such that it acts like an application server and/or application function from the perspective of a network device, such as a PCRF. The CAN-EG can perform operations and behave like an application server such that the service entities and/or MOs, which the CAN-EG is servicing, are transparent to the network.

Each of these exemplary embodiments of the invention is described in more detail below.

In accordance with the exemplary embodiments of the invention, the CAN-EG operates as a functional network entity that enables:
Establishment of a Bearer to match a particular service, user and operator profile;
Modification of the Bearer in real-time to adapt to changing network conditions;
Modification of the Bearer in real-time to adapt to changing service characteristics;
Reporting of network and UE metrics in a consolidated manner to the service provider, by aggregating metrics from multiple network elements;
Reporting of the implication of the network and UE metrics to the Service Entities. Further, the CAN-EG can interpret these metrics and report an interpretation of the CAN-EG to a service entity or other network node. In accordance with the exemplary embodiments of the invention the CAN-EG can process the network and/or UE metrics to create an interpretation for a service entity, such as a media optimizer. The interpretation can be specific for a new or existing communication of a service to the UE and/or for the establishment of an initial Bearer or establishment of a new Bearer of the network which is optimum for the communication.

In accordance with the exemplary embodiments of the invention, the policy rules of the CAN-EG can include different threshold levels for different metrics/measurements as well as for a function of operations of the CAN-EG. The thresholds can be used for initiating and/or detection for the changing services, collecting metrics/measurements and interpretation of collected metrics/measurements. The thresholds may be, all or in part, programmed by a manufacturer, a user, administrator and/or a service entity.

CAN-EG Policy Rule Examples:
Functionality that is provided by the CAN-EG to one or more service entities (SEs). Note that an SE(n), as labeled below, each represents a particular service entity of a plurality of service entities to whom the policy rule depicted applies.
   an SE1 may be only able to request Bearer establishment and nothing more (no mid-stream changes or metrics reporting) “if” that is all SE1 has license for;
   an SE2 may be allowed to establish and modify Bearer but no metrics “if” that is all SE2 has license for;
   an SE3 may get only IP-CAN metrics “if” that is all SE3 has license for;
   an SE4 may get only cell-sector metrics “if” that is all SE4 has license for;
   an SE5 may only get UE metrics “if” that is all SE5 has license for; and/or
   an SE6 may get all metrics and do all Bearer management “if” that is all SE6 has license for.
Policies or rules, which can specify characteristics of an SE, UE, and or operator, can be enacted at the CAN-EG regarding different types of metrics, measurements, and/or information to be provided to particular one or more service entities and/or media optimizers (SE). For example:
   an SE1 may have been specified a characteristic to get raw metrics, and/or
   an SE2 may have been specified a characteristic to get interpreted metrics
In addition to the policies or rules, thresholds can be used by the CAN-EG to provide a custom or different frequency for reporting of metrics to the SE, such as for particular types of SE devices.

These thresholds and/or the specified characteristics can be derived by the CAN-EG based on information such as an SLA and/or other agreement of at least one of the SE, UE, and an operator. In addition, thresholds as well as the specified characteristics can determined by the CAN-EG in view of the content type which is to be, or is, provisioned by the SE.

CAN-EG Threshold Level Examples:
an SE-1 may be authorized with a threshold of a million requests a month after which requests are rejected; and
an SE-2 is authorized with a threshold of a million requests per the license after which the rate for handing the next tier of requests (e.g., next 100K requests) may be charged at a different rate.

In accordance with the exemplary embodiments of the invention, the requests can comprise at least Bearer establishment and/or Bearer modification requests to the CAN-EG from the SEs. As stated above, these requests can occur during a session where the SE is providing services/applications via the CAN-EG.

It is noted that the above described policy examples and threshold examples are non-limiting, in accordance with the exemplary embodiments of the invention. Any one or more of these policies and/or thresholds may be used alone or in conjunction with another one or more policies and/or thresholds. Further, the specific amounts and/or values and/or times associated with any of these policies and/or thresholds are for example purposes only, and any of these amounts and/or values and/or times can be determined by a manufacturer, user, and/or operator, to name only a few.

In accordance with the exemplary embodiments of the invention, this single functional entity or CAN-EG in the network provides a novel operation to provide benefits including:
providing metrics for unicast, multicast, and broadcast services;
providing network metric/measurement interpretation of metrics for unicast, multicast, and/or broadcast services;
performing Bearer management for unicast, multicast and broadcast services;
aggregating metrics to operators (which service used which resources and how much);
reporting to services/applications (network behavior in support of their service) to show SLA compliance;
deployment as a revenue-generating value-added service in a shared network environment;
providing a single extensible interface for providing metric/measurements and/or interpretations to service entities; and
providing the single extensible interface to Service Entities for licensing and/or inclusion in standards.

Further, it is noted that although the description of the exemplary embodiments of the invention may be directed at LTE networks, such as 4G networks, the exemplary embodiments of the invention may be practiced in other types of networks where real-time Bearer management and Service Management is required, including 3G networks, CDMA and WIMAX networks. Regarding 3G networks, as discussed below, certain network devices may not be available, such as a mobility management entity (MME). In this case, the CAN-EG can operate similarly, as in accordance with the exemplary embodiments, with another device of the 3G network, such as a GMLC, instead of an MME.

Exemplary Interfaces for the CAN-EG to Receive Cell/Sector Metrics

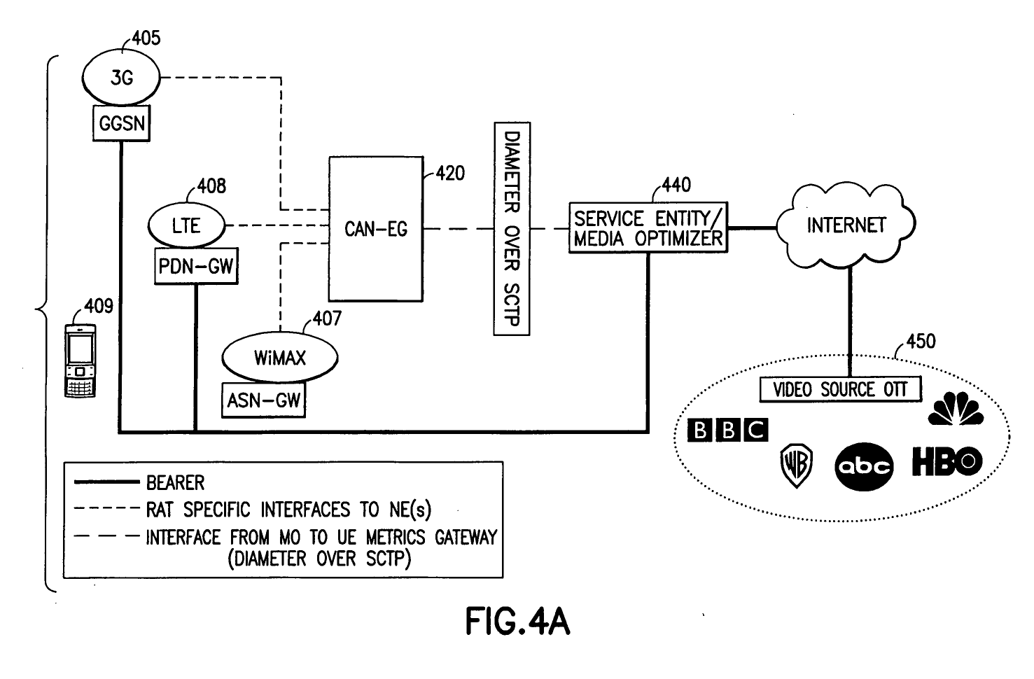

FIG. 3 illustrates CAN-EG communication architecture in accordance with the exemplary embodiments of the invention. The exemplary embodiments of the invention provide for at least six interfaces which are used by the CAN-EG. Four of these interfaces can be to the network elements, one interface is to a UE, and one is an external interface. The types of information available across each of the four network interfaces are either almost mutually exclusive or have different levels of granularity. The level and type of optimization exercised by the service entity is dependent on the type of information made available by the network elements to the CAN-EG across the four interfaces to the network elements and/or the interface to the UE.

As illustrated in FIG. 3, the CAN-EG 320 communicates over Diameter interface 301 with the PCRF 360. In addition, the CAN-EG communicates over a S1g interface 302 with the MME 370. Further, the CAN-EG communicates over a GTP-u interface 303 with the eNodeB 390. It is noted that the eNodeB may be any type of control or base station, including a ZenBcontroller. The CAN-EG may communicates over a proprietary interface 304 with the UE 380. A 305 interface, which uses diameter over SCTP, allows the CAN-EG 320 to communicate with the service entity/media optimizer 340. Additionally, the CAN-EG 310 can communicate over the 306 interface with the HSS 310. It is noted that the thresholds, policies, rules and/or the specified characteristics, as stated above, may be collected from the HSS 310 by the CAN-EG.

More specifically, in accordance with the exemplary embodiments of the invention, the CAN-EG interfaces, as illustrated in FIG. 3, are as follows:
1. The interface 301 between the CAN-EG 320 and the PCRF 360 is an enhanced Rx interface which uses a Diameter protocol. Reference regarding standards based features of this interface may be found in 3GPP TS 23.401 V10.5.0 (2011-09), 3rd Generation Partnership Project; Technical Specification Group Services and System Aspects; General Packet Radio Service (GPRS) enhancements for Evolved Universal Terrestrial Radio Access Network (E-UTRAN) access (Release 10). In accordance with the exemplary embodiments of the invention at least one novel extension is configured for this interface for use with the CAN-EG.
2. The interface 302 to the MME uses a standard based protocol, but not specifically for the standard intended use with a GMLC interface. Reference regarding standards based features of this interface may be found in 3GPP TS 29.274 V11.0.0 (2011-09) Technical Specification 3rd Generation Partnership Project; Technical Specification Group Core Network and Terminals; 3GPP Evolved Packet System (EPS); Evolved General Packet Radio Service (GPRS) Tunnelling Protocol for Control plane (GTPv2-C); Stage 3 (Release 11); and in 3GPP TS 29.281 V11.0.0 (2011-09) Technical Specification 3rd Generation Partnership Project; Technical Specification Group Core Network and Terminals; General Packet Radio System (GPRS) Tunneling Protocol User Plane (GTPv1-U) (Release 11). This interface is the focus of this feature request.
   a. The interface 302 is a SLg diameter interface that is primarily used to communicate mid-stream channel conditions to the CAN-EG 320, which may be aggregated by the CAN-EG 320 with other metrics sent to the service entity and/or media optimizer (SE/MO) 340. The MME 370 also reports UE metrics (as collected) to the SE/MO 340 via the CAN-EG 320. This reporting may be performed periodically as well (e.g., every 500-2000 ms).
   b. The interface 302 comprises an OAM&P component such that the MME and the CAN-EG can mutually authenticate across this interface. It is noted that, as stated above, in a 3G network there is no MME and, as such, the interface 302 of the CAN-EG can be to another network device, such as a GMLC. In this case, the CAN-EG and the other device of the 3G network can perform similar novel operations as with the MME.
3. The interface 303 is a GTP-u Interface. This interface allows a GPRS Tunneling Protocol-User plane between the CAN-EG and a network node, such as the eNode B 390. In accordance with the exemplary embodiments of the invention, functions and/or elements of one or more network devices and/or the CAN-EG can be consolidated into a single device, such as a network device. In this case, connectivity between the CAN-EG and another consolidated network node, such as an eNodeB, can be established via consolidated elements, which may or may not be using the GTP-u interface.
4. The interface 304 is a proprietary interface to the UE 380 that could be used either in-band or out-of-band. The interface 304 is used for proprietary messages between the CAN-EG 320 and the UE 380.
5. The interface 305 to service entities such as the SE/MO 340 is a diameter interface using SCTP. The SE/MO 340 may be external to the network. The interface 305 is based on the diameter protocol so as to be 3GPP compliant. As stated above, messages exchanged over the interface 305 may be in a SOAP format. The SOAP format makes these messages easier to read and distinguish from other types of diameter messages.
6. The interface 306 is an operational interface to the HSS (SLh). The interface 306 is compliant with standards as defined in 3GPP specification 3GPP TS 29.173 V10.0.0 (2011-03) Technical Specification 3rd Generation Partnership Project; Technical Specification Group Core Network and Terminals; Location Services (LCS); Diameter-based SLh interface for Control Plane LCS (Release 10). This interface can be used by the CAN-EG to determine a serving MME.

In accordance with the exemplary embodiments of the invention, the extension of defined 3GPP protocols and functionality, as described above, provides further benefit such that:
to the MME the CAN-EG appears functionally as a GMLC, but uses the metrics for real-time service modification;
to the PCRF the CAN-EG appears functionally as an Application Function;
to the eNodeB (or other similar device) the CAN-EG appears functionally as a S-GW across the GTP-u interface, over which proprietary metrics are reported; metrics are used for real-time service modifications;
the CAN-EG hides (e.g., firewalls) the complexity of the Wireless Access Network (3/4G, WiMAX) from the applications and services providers;
the CAN-EG hides the network topology from services/applications providers that are “in the cloud”;
the CAN-EG integrates the Control Plane functions of an MBMS-GW; and
the CAN-EG can act as a gateway to a network, such as a wireless communication network for collecting metrics of the network, and for enabling either of establishment and enablement of a Bearer for a service, such as a service from a service entity outside the network. Including the CAN-EG can collect metrics based on requests for metrics and/or a subset of metrics and/or all metrics and/or interpretation(s) of metrics of the network from a device which may be external to the network, such as a service entity.

Using the above defined interfaces (301-306), the CAN-EG can provide network metrics to any service/application such that they could benefit from them and perform the Bearer management on behalf of the service entities.

Network conditions and/or metrics that are received over the interface 301 from the PCRF include:
Tracking Area Updated with SGW change
Tracking Area Updated without SGW change
Routing Area Updated without SGW change
Routing Area Updated without SGW change
Handoff (intra network), (this the same case as Tracking Area Update
(above)
Handoff (inter RAT)
Routing information change
Change in type of IP-CAN
Loss/recovery of transmission resources
Location change (serving cell)
Location change (serving area)
Location change (serving CN node)
UE IP address change
SGSN Change
QoS Change
RAT Change
TFT Change
PLMN change
Loss of Bearer
Recovery of Bearer
IPCAN Change
RAI Change
User Location change
QoS Exceeded
UE IP Address release
Default EPS Bearer QoS Change
AN GW Change
Successful allocation of resources
Resource Modification Request (UE triggered)
TAI Change
ECGI Change
Routing Rules changed

In addition, network conditions and/or metrics that are received over the interface 302 from the MME include:
SGSN Change
Location (current, last known, initial)
Location accuracy (for vertical and horizontal location planes) QoS
Accuracy fulfillment
Age of location
Velocity Estimate
ECGI

Further, messages exchanged over the interface 305 may be in a SOAP format. The SOAP format makes these messages easier to read or distinguish than other types of diameter messages.

Standards Accepted Measurements/Metrics Modified for Use by the CAN-EG

The measurements/metrics identified below can be found in 3GPP TS 32.425 V10.5.0 (2011-06); 3rd Generation Partnership Project; Technical Specification Group Services and System Aspects; Telecommunication management; Performance Management (PM); Performance measurements Evolved Universal Terrestrial Radio Access Network (E-UTRAN). Some or all of these metrics may be modified for use by the CAN-EG as in accordance with the exemplary embodiments of the invention. These metrics/measurements may be identified as follows:
metrics for unicast, multicast, and broadcast services;
Average DL cell PDCP SDU bit-rate metric;
Average DL cell PDCP SDU bit-rate;
Average number of active UE's on the Downlink;
Average number of active UE's on the Downlink;
Average number of active UE's on the Uplink;
Average number of active UE's on the Uplink with data to send, for QoS;
Maximum Processor Usage <Cause Group Values>;
Attempted ×2 based outgoing inter-eNB handover preparations; and
Attempted outgoing inter-eNB handover preparations;

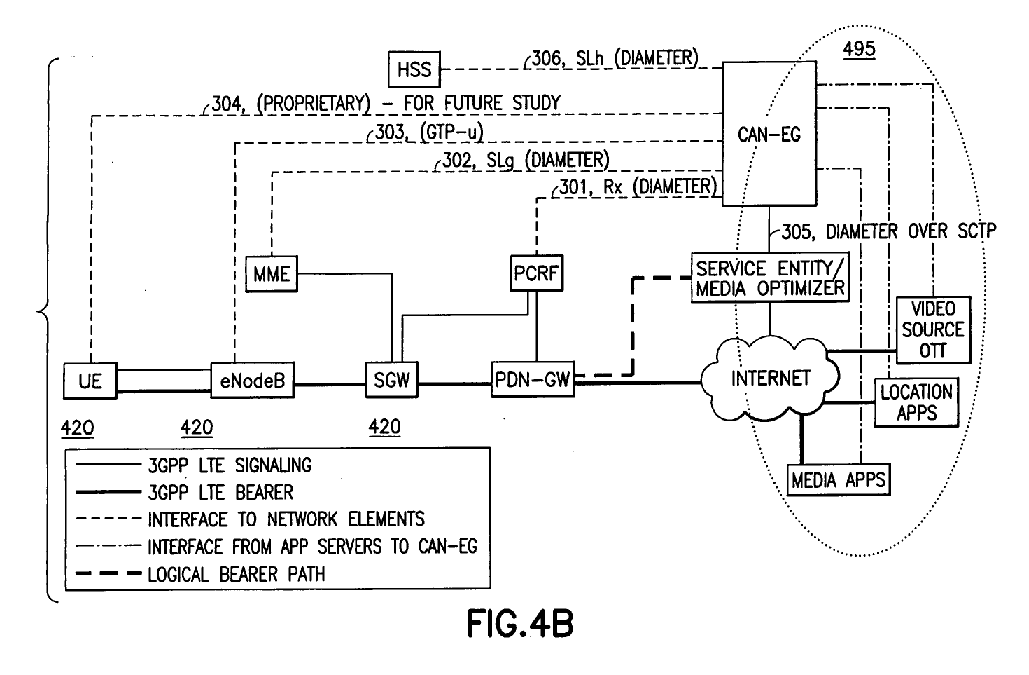

Regarding FIG. 4A, there is illustrated a CAN-EG communication architecture in accordance with the exemplary embodiments of the invention. As illustrated in FIG. 4A the CAN-EG 420 is connected to a service entity and/or media optimizer (SE/MO) 440 using the novel diameter interface over SCTP as a metric gateway, in accordance with the exemplary embodiments of the invention. The SE/MO 440 is also connected to a video source 450 which may be any type of service entity which can provide services, such as downloading or streaming content, to the UE 409. The networks to which the CAN-EG 420 can interface and perform the operations, in accordance with the exemplary embodiments of the invention, include 3G networks 405, and LTE networks 408 and/or WiMAX networks 407, to name only a few. In addition, user equipment 409 may connect to any one of these networks. In accordance with the exemplary embodiments of the invention, the novel operations of the CAN-EG, as described herein, may benefit any of these network types, the SE/MO 440 as well as the UE which is connecting to the networks for services from the service entities of 450. The services provisioning's which are benefitted include but are not limited to downloads of streaming video provided by at least one of the service entities.

FIG. 4B illustrates a similar CAN-EG communication architecture as shown in FIG. 3. However, as identified in oval 495, the CAN-EG may interface with any number of applications and/or service entities via the interface 305 diameter over SCTP. Oval 495 comprises a video source OTT, as well as location and media application providers. For example, the CAN-EG may interface with the location apps in order to identify further information about a location of a UE which is to be, or is already, provided a service. Location information can be used by the CAN-EG to identify potential changing conditions of the network's ability to communicate with the UE. Further, the location information can be used by the CAN-EG to derive interpretations of network metrics/measurements for a service entity.

Key Usage Scenarios for Unicast Services in a Macro Network

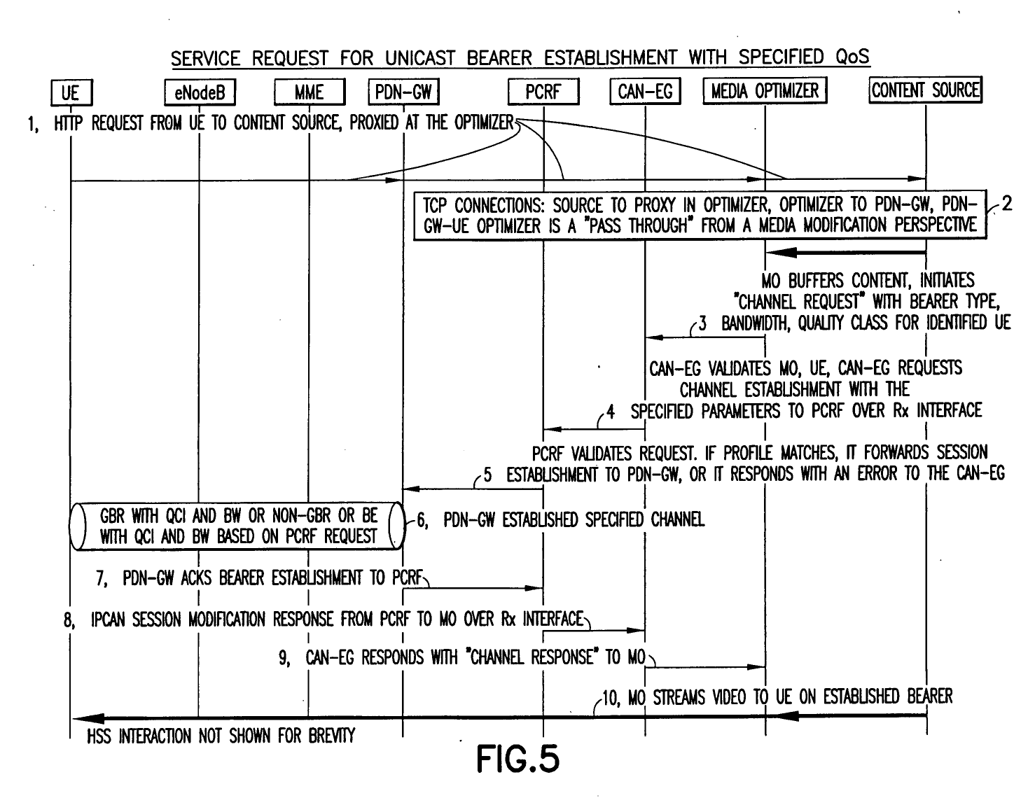

In accordance with an exemplary embodiment of the invention, the CAN-EG can respond to a service request for a Bearer establishment which must conform to a specified QoS, such as for an SLA between an operator and a subscriber. FIG. 5 illustrates a communication flow of a service request for unicast Bearer establishment with a specified QoS.

As illustrated in FIG. 5, item 1 shows an HTTP request from a UE to the content source, which may be proxied at an optimizer. In item 2, based on the request there are established connections, such as TCP connections, from the source UE to the optimizer, from the optimizer to the PDN-GW and from the PDN-GW to the UE. Item 3, in accordance with the exemplary embodiments, the MO buffers content, initiates an “channel Request” to the CAN-EG which includes a Bearer type as well as a required bandwidth and quality class for the UEs request. It is noted that this request received at the CAN-EG can be user specific. In accordance with the exemplary embodiments, as illustrated in item 4 of FIG. 5, the CAN-EG validates the MO and the UE. Then the CAN-EG requests channel establishment with the specified parameters over the interface to the PCRF. As shown in item 5, the PCRF validates the request and, if there is a profile match, the PCRF forwards a session establishment to the PDN-GW, or else the PCRF responds with an error message to the CAN-EG. As in item 6, there is an established specified channel 510 between the PDN-GW and the UE. In item 7, the PDN-GW acknowledges the established tunnel to the PCRF. In item 8 there is an IPCAN session modification response from the PCRF to the CAN-EG over the interface 301. In item 9, in accordance with the exemplary embodiments, the CAN-EG responds such as with a “Channel Response” to the MO. Then, as indicated in item 10, the MO streams video to the UE on the established Bearer.

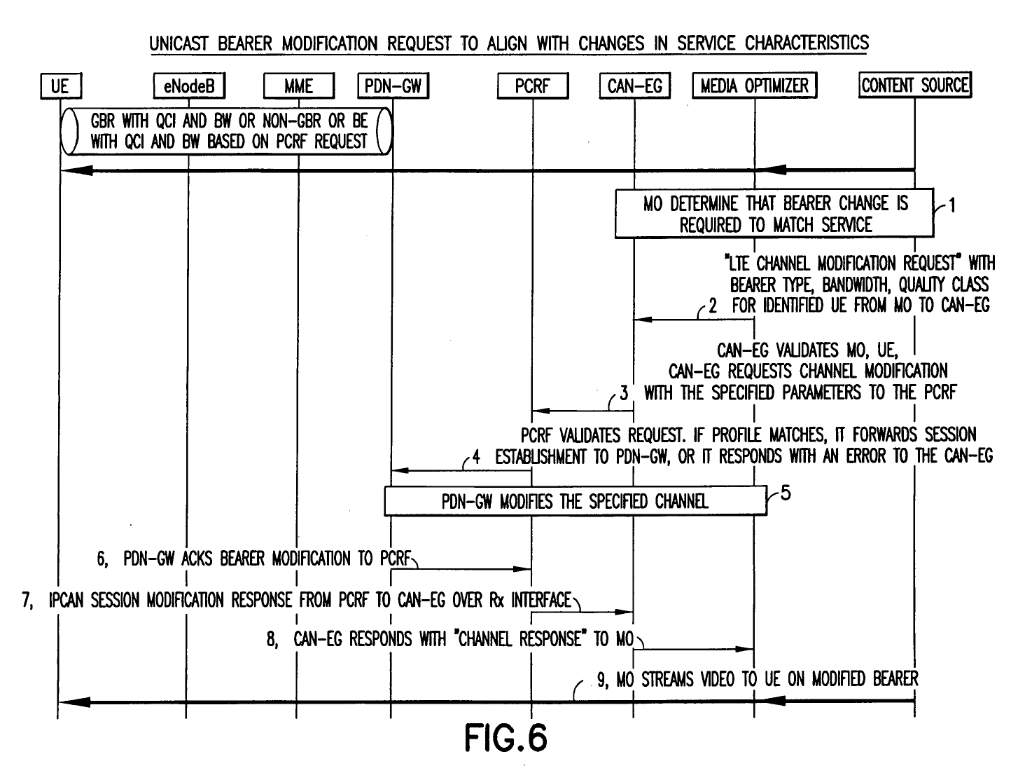

FIG. 6 illustrates a unicast Bearer modification request in accordance with the exemplary embodiments of the invention. In FIG. 6 the Bearer modification request is due to a change in service characteristics for a UE. In accordance with the exemplary embodiments of the invention, this Bearer modification request can be serviced by the CAN-EG at any time during a session. As illustrated in FIG. 6, an existing Bearer channel 610 has already been established for a communication between the content source and the UE. The channel 610 may have been established in a similar manner as the tunnel 510 of FIG. 5, as discussed above.

Item 1 of FIG. 6 illustrates that the MO connected to the content source has determined that a Bearer change is needed for a download by the UE. In accordance with the exemplary embodiments of the invention an “Channel Modification request” is received from the MO by the CAN-EG. The CAN-EG validates the MO and/or the UE as illustrated in item 3 and the CAN-EG requests a channel modification with the specified parameters from the PCRF. Then, as in item 4, the PCRF validates the request from the CAN-EG and if the profile matches the PCRF forwards a new session establishment to the PDN-GW. Or, such as if the profile doesn't match, the PCRF responds with an error to the CAN-EG. As shown in item 5, the PDN-GW modifies the specified channel. Then at item 6 the PDN-GW acknowledges a Bearer modification to the PCRF. As shown in item 7 there is an IPCAN session modification response from the PCRF to the CAN-EG over the Rx interface 301. In accordance with the exemplary embodiments of the invention, as illustrated in item 8 the CAN-EG responds with a “Channel Response” to the MO. Then, as shown in item 9, the content source, via the MO, streams video to the UE on the modified Bearer.

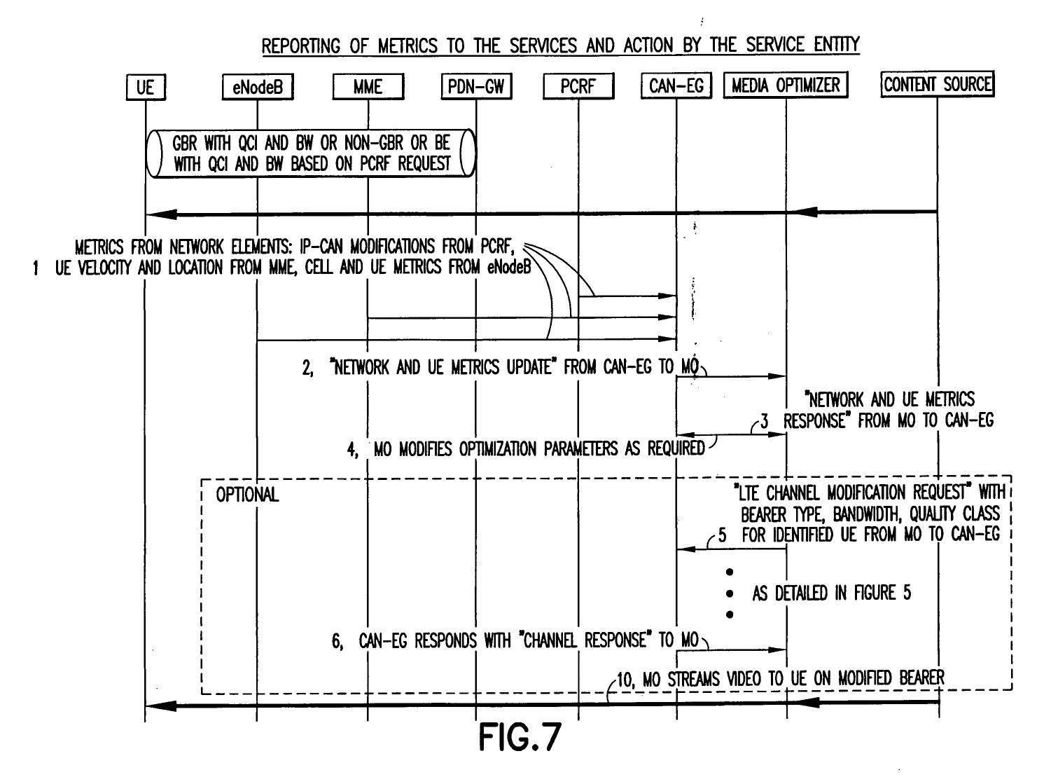

FIG. 7 illustrates an operation in accordance with the exemplary embodiments of the invention of reporting of metrics to the services and action by the service entity. As illustrated in FIG. 7, an existing tunnel 710 has already been established for a communication between the content source and the UE. The tunnel 710 may have been established in a similar manner as the tunnel 510 of FIG. 5, as discussed above. As illustrated in item 1, metrics are received by the CAN-EG from network elements including the PCRF, the MME, and the eNodeB. As shown in item 2, in accordance with the exemplary embodiments of the invention, the CAN-EG provides a type of “Network and UE metric Update” to the MO. Then, as shown in item 3, in response the CAN-EG receives a type of “Network and UE metric Response” from the MO. Then, as shown in item 4 the MO modifies optimization parameters as required. In accordance with an embodiment of the invention, as shown in item 5 the CAN-EG may receive from the MO a type of “channel Modification Request” which includes at least one of a Bearer type, bandwidth requirement, and a quality class type identified for the UE. Further, in accordance with the exemplary embodiments of the invention, if the MO requests more or less bandwidth, such as based on the UE requirements or an SLA, then the operations as discussed above with regards to FIG. 5 may be performed. Then, in accordance with the exemplary embodiments of the invention, after one or more of these operations the CAN-EG responds to the MO with a type of “Channel Response” message. Then, as shown in item 7, the content source, via the MO, streams video to the UE on the modified Bearer.

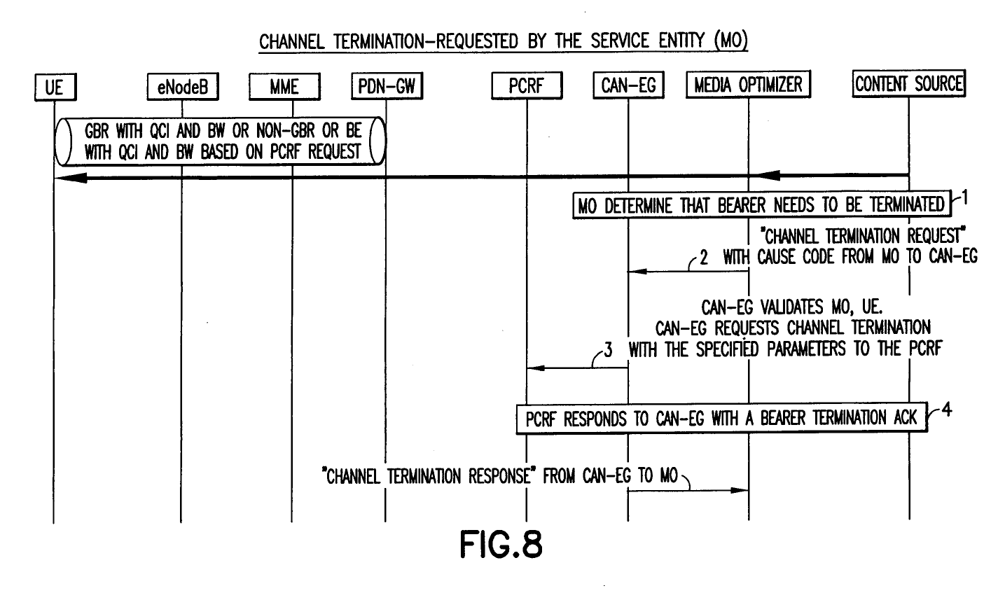

FIG. 8 illustrates an operation, in accordance with the exemplary embodiments, of an channel termination in response to a request by a service entity, such as an MO. the invention of reporting of metrics to the services and action by the service entity. As illustrated in FIG. 8, an existing tunnel 810 has already been established for a communication between the content source, via the MO, and the UE. The tunnel 810 may have been established in a similar manner as the tunnel 510 of FIG. 5, as discussed above. As illustrated in item 1, the MO determines that a Bearer for the communication needs to be terminated. In accordance with the exemplary embodiments of the invention, the CAN-EG receives a type of “channel Termination Request,” possibly including a cause code and/or specified parameters, from the MO. In accordance with an exemplary embodiment of the invention, as shown in item 3, the CAN-EG validates the MO and/or the UE. Then the CAN-EG sends a request to the PCRF to perform a channel termination, as in item 3. The request may include the cause code and/or the specified parameters. As shown in item 4 the PCRF responds to the CAN-EG with a Bearer termination acknowledgment. Then, in accordance with the exemplary embodiments of the invention, at item 5 the CAN-EG sends a type of “Channel Termination Response” to the MO.

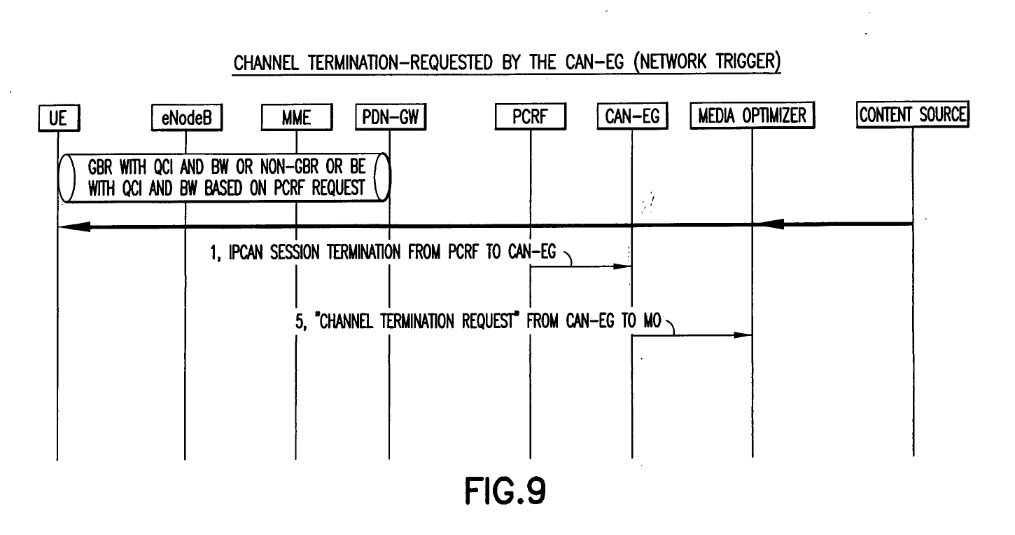

Further, FIG. 9 illustrates another exemplary embodiment of the invention comprising a channel termination request performed by the CAN-EG. As illustrated in FIG. 9, an existing tunnel 910 has already been established for a communication, via the MO, between the content source and the UE. As illustrated in item 1 of FIG. 9 a type of IPCAN session termination message from the PCRF is received at the CAN-EG. Then a type of “Channel Termination request” is sent to the MO by the CAN-EG, as shown in item 5.

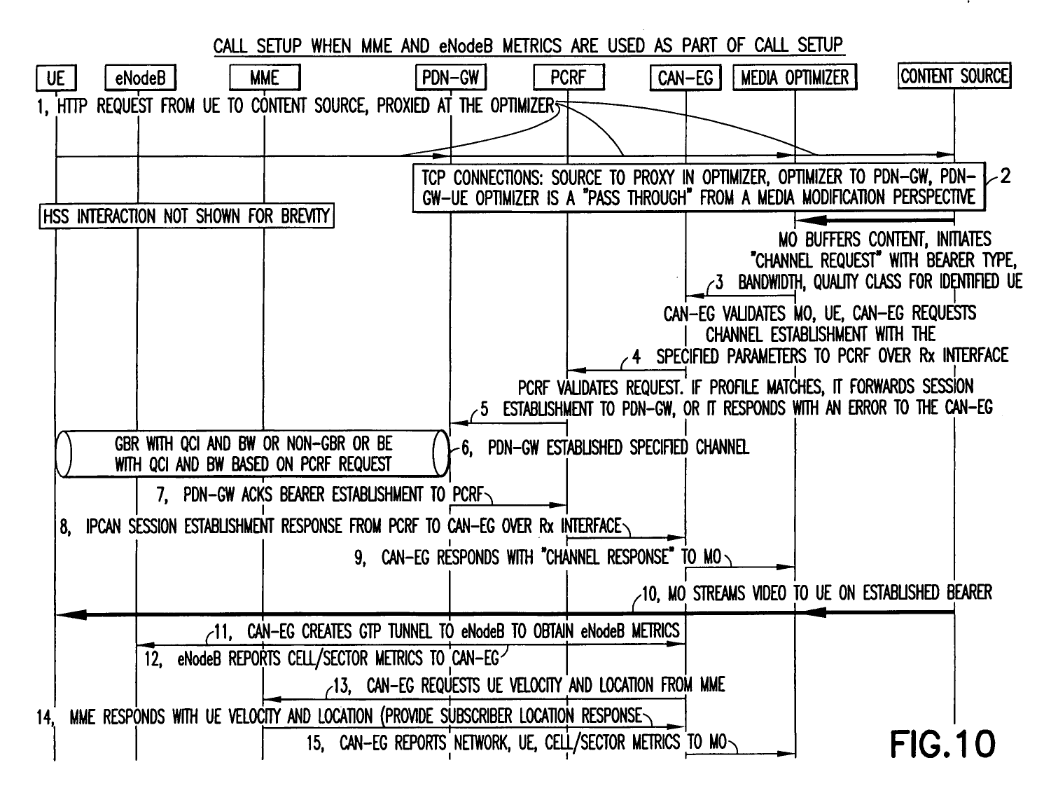

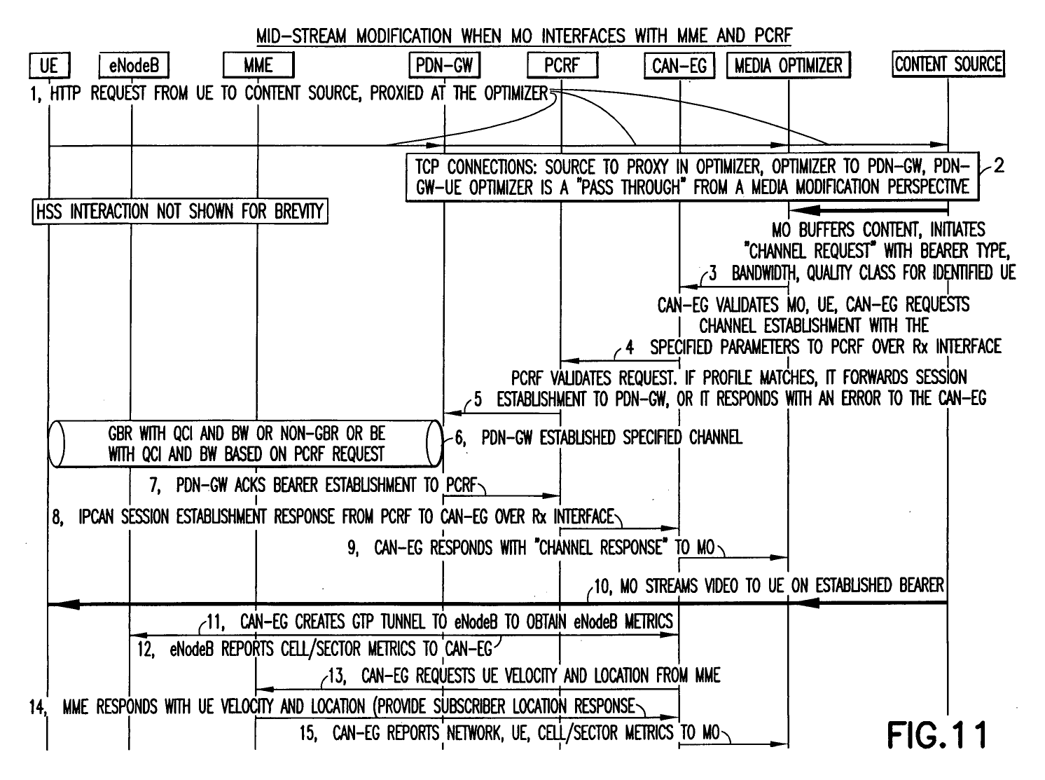

In accordance with another exemplary embodiment of the invention, as illustrated in FIGS. 10 and 11, the CAN-EG can be used for call/session establishment based on video parameters and UE information, as well as for a mid-call modification based on UE information, such as from the MME or eNodeB.

In FIG. 10 there is illustrated in item 3 that the CAN-EG receives a type of “channel Request” message including specified parameters from a network node such as the media optimizer. Then, as shown in item 4, the CAN-EG validates the MO and/or UE with the PCRF, and requests channel establishment using the specified parameters received from MO. In accordance with the exemplary embodiments, once the channel 10 has been established the CAN-EG sends a type of “Channel Response” message to the MO, as in item 9. Further, in accordance with the exemplary embodiments of the invention, as shown in items 11 and 12 of FIG. 10, the CAN-EG creates a GTP tunnel to the eNodeB and obtains eNodeB metrics. As shown in items 13 and 14 of FIG. 10, in accordance with the exemplary embodiments of the invention, the CAN-EG requests UE velocity and location information from the MME and receives the metrics/measurements regarding this information from the MME. In another exemplary embodiment of the invention the CAN-EG reports an indication of the UE cell/sector metrics to the MO, as in item 15 of FIG. 10. This is used by the MO to evaluate the need to change the service parameters in real time as well as request modification of the Bearer as outlined in FIG. 7.

In more detail, the operations with regards to FIG. 10 include the UE attaching to the network and being assigned a default Bearer, as defined by the user-profile in the HSS. It is over this default Bearer that the user accesses a video-site (for example YouTube, Netflix etc. . . . ) with the HTTP request being directed over the default Bearer. The HTTP request is directed by the PDN-GW to the MO (typical configuration). The MO requests the video from the source (e.g. YouTube) and buffers the content. In accordance with the exemplary embodiments the MO initiates a type of “Create channel” request to the CAN-EG. The request including the subscriber/user's privileges with respect to source provider along with session information. Further in accordance with the exemplary embodiments of the invention, the CAN-EG extracts the video Optimizer parameters from the MO request and initiates a Channel request towards EPC (PCRF). It also requests the identity of the serving eNodeB. The PCRF validates the request and request the PGW to start a Bearer based on the request with the specified QCI from the MO. Then after a new Bearer is created the PGW sends an acknowledgment to PCRF indicating a success or failure of the request and the identity of the serving eNodeB. In accordance with the exemplary embodiments of the invention, the CAN-EG receives the response from the PCRF. Then a Create channel request response is conveyed to the MO. The MO streams the video which is buffered from the content source on the newly created Bearer. Once the Bearer is created for the subscriber, CAN-EG creates a GTP-u tunnel to the serving eNodeB. In accordance with the exemplary embodiments the eNodeB sends the UE related metrics to CAN-EG over this GTP-c tunnel. Further, in accordance with the exemplary embodiments the CAN-EG identifies the MME which is serving this user from the HSS and sends a request for “Location information” of this user. The MME responds with user “Location information” to CAN-EG and the CAN-EG consolidates these UE metrics from eNodeB and MME and sends a session update to MO.

Further, it is noted that at least a location and velocity of the UE can change midstream or during a setup or established call/session. In accordance with the exemplary embodiments of the invention, the location and velocity may be determined by the CAN-EG by communicating, over the interface 304, with a location application as discussed above with regards to FIG. 4B. In accordance with the exemplary embodiments of the invention, the CAN-EG can help provide a mid-stream modification regarding a change of Bearer.

FIG. 11 illustrates another exemplary embodiment of the invention which relates to mid-stream modification of a Bearer performed using the CAN-EG. FIG. 11 illustrates novel operations performed as indicated with at least items 3, 9, 11 and 13-15 of FIG. 11 for providing this benefit to a network node such as the MO and/or content source of FIG. 11. Further, the CAN-EG may provide metrics/measurements and/or interpretations to a service entity or media optimizer in order to change a Bearer to a lesser bandwidth capable Bearer. This may be done if the present Bearer for a service entity communication is overly large for the required service, and the additional bandwidth may be more efficiently used for another communication.

In more detail, the operations with regards to FIG. 11, in item 1 the PDN-GW receives a request from the UE to a content source proxied by the media optimizer (MO. The PDN-GW passes this information to the MO which, in item 2, provides it to the content source. In item 3, the MO then buffers content and initiates a channel request which includes an indication required bandwidth and QoS for service to the UE, via the CAN-EG. In accordance with the exemplary embodiments, in item 4 the CAN-EG validates the MO and/or UE and requests channel establishment with the specified parameters to the PCRF over an Rx interface. In item 5 the PCRF validates the request. Then the channel is established as per items 6 and 7. In item 8 an IP CAN session establishment response message is sent to the CAN-EG over the Rx interface. In item 9 the CAN-EG sends a “Channel Response” message to the MO and in item 10 the MO streams video to the UE on the established bearer.

Further, in FIG. 11 there is illustrated an exemplary embodiment of the invention where the CAN-EG creates a GTP tunnel to the eNodeB to obtain eNodeB metrics. After receiving the metrics, as in item 12, the CAN-EG requests a UE velocity and location from the MME. After the MME responds with the UE metrics, in accordance with the exemplary embodiments and the CAN-EG, as in item 15, reports an indication of the metrics to the MO.

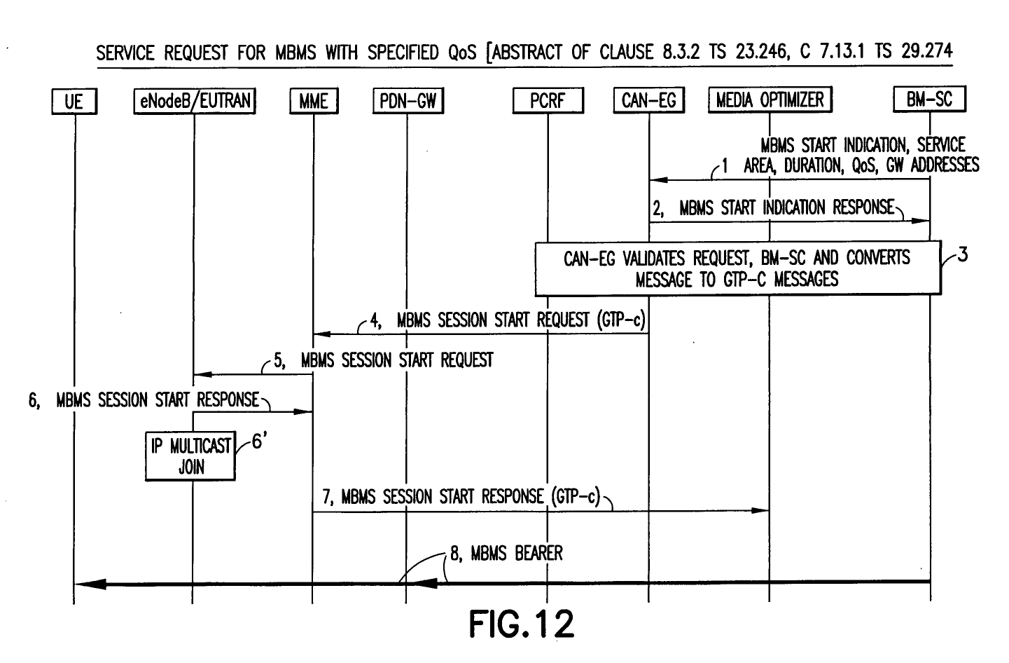

With regards to FIG. 12, there is illustrated a service request for MBMS with a specified QoS. The operations, as in accordance exemplary embodiments of the invention, are defined in items 1, 2, and 3 of FIG. 12. Particularly, in item 1 the MBMS start indication, service area, duration, QoS, and/or gateway address(s) is sent from the BM-SC to the CAN-EG. In item 2 the CAN-EG responds to the BM-SC with a MBMS start indication. Then, as in item 3 the CAN-EG validates the request and/or the BM-SC and converts the message(s) to GTP-c message(s). Then at item 4, the CAN-EG sends an MBMS Start Request (GTP-c) to the MME for the requested MBMS.

It is noted that the order of the items, as in FIGS. 5-12, are non-limiting. Thus, in accordance with the exemplary embodiments of the invention, these operations may comprise more or less of these items, and the items of these operations may be performed in a different order.

CAN-EG Capabilities For Reporting To “Customers”

Further, in accordance with the exemplary embodiments of the invention, the CAN-EG can retain metrics, measurements, statistics and/or other information regarding service level metrics that it reports to its “customers” (e.g., operators, media optimizers and/or service entities). These metrics, measurements, statistics and/or other information can be provided to the “customers” and/or formulated in a report of a type which when provided to the “customers” shows them how they are using the CAN-EG and/or metrics related to any threshold crossing. Examples of metrics, measurements, statistics and other information used for such “customer” reporting includes:
Functionality that is provided by the CAN-EG to one or more service entities (SEs).
# of requests were made by a particular MO/service entity in a busy hour,
# successful (exact), conditionally successful, failed requests in a busy hour (or daily),
# of network changes reported per busy hour for all active subscribers,
# of mid-stream changes initiated by MO/service entity in busy hour due to network changes, and
Average and max session duration

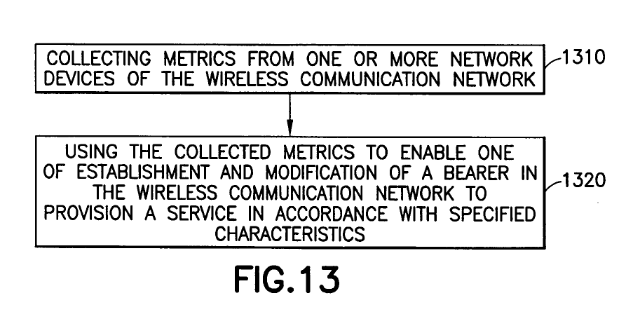

FIG. 13 is a block diagram illustrating a method in accordance with the exemplary embodiments of the invention. In block 1310 there is collecting metrics from one or more network devices of the wireless communication network. Then in block 1320 there is using the collected metrics to enable one of establishment and modification of a Bearer in the wireless communication network to provision a service in accordance with specified characteristics.

The exemplary embodiments of the invention as described in the paragraph above, where using the collected metrics to enable one of the establishment and the modification of the Bearer comprises providing an indication of the collected metrics to a service entity to provision the service using the Bearer to a user equipment associated with the wireless communication network.

The exemplary embodiments of the invention as described in the paragraphs above, where the specified characteristics are specified characteristics of at least one of the service entity, the at least one user equipment, and the wireless communication network.

The exemplary embodiments of the invention as described in the paragraphs above, where the collecting metrics comprises collecting from the user equipment information regarding at least one of a location and a velocity of the user equipment.

The exemplary embodiments of the invention as described in the paragraphs above, where the indication of the collected metrics is provided to the service entity, at least in part, over a diameter interface using a stream control transmission protocol.

The exemplary embodiments of the invention as described in the paragraphs above, where the indication of the collected metrics comprises at least one of the collected metrics and an interpretation of the collected metrics.

The exemplary embodiments of the invention as described in the paragraphs above, where the indication of the collected metrics provided to the service entity is determined based on at least one of a content type of the service and a policy associated with at least one of the service entity and the user equipment.

The exemplary embodiments of the invention as described in the paragraphs above, where the collecting metrics comprises collect the metrics over a diameter interface from a policy control and charging rules function of the wireless communication network.

The exemplary embodiments of the invention as described in the paragraphs above, where the collecting metrics comprises receiving one or more of the metrics over a diameter interface from a mobility management entity of the wireless communication network.

The exemplary embodiments of the invention as described in the paragraphs above, where the collecting metrics comprises collecting metrics associated with at least one of a cell and sector of the wireless communication network.

The exemplary embodiments of the invention as described in the paragraphs above, where the metrics associated with the at least one of the cell and the sector of the wireless communication network is collected from a base station of the wireless communication network.

The exemplary embodiments of the invention as described in the paragraphs above, where the modification of a Bearer in the wireless communication network is performed based on a request from a service entity located outside the wireless communication network.

The exemplary embodiments of the invention as described in the paragraph above, where the request from the service entity is received over a diameter interface using a stream control transmission protocol, where the request comprises one of a request to establish a Bearer and a request to modify a Bearer of the wireless communication network, and where the Bearer is for provisioning a service of the service entity to at least one user equipment over the wireless communication network.

The exemplary embodiments of the invention as described in the paragraphs above, where the at least one of the collected metrics in is provided to the service entity to one of establish and modify the bearer to be aligned with a specified characteristic of at least one of the service entity, the at least one user equipment, and the wireless communication network.

The exemplary embodiments of the invention as described in the paragraphs above, where the collecting metrics comprises receiving one or more of the metrics from user.

The exemplary embodiments of the invention as described in the paragraphs above, equipment of the at least one user equipment comprising information regarding at least one of a location and a velocity of the user equipment.

The exemplary embodiments of the invention as described in the paragraphs above, where the collected metrics are provided to the service entity, at least in part, over the diameter interface using the stream control transmission protocol.

The exemplary embodiments of the invention as described in the paragraphs above, where the collecting metrics comprises receiving one or more of the metrics over a diameter interface from a policy control and charging rules function of the wireless communication network.

The exemplary embodiments of the invention as described in the paragraphs above, where the collecting metrics comprises receiving one or more of the metrics over a diameter interface from a mobility management entity of the wireless communication network.

The exemplary embodiments of the invention as described in the paragraphs above, where the indication of the collected metrics comprises at least one of the collected metrics and an interpretation of the collected metrics.

Further, in accordance with the paragraph above, the interpretation based on the collected metrics of network conditions is associated with at least one Bearer of the wireless communication network.

In addition, the method according to the exemplary embodiments of the invention may be performed by an apparatus comprising at least one processor, and at least one computer readable memory embodying at least one computer program code, where the at least one computer readable memory embodying the at least one computer program code is configured, with the at least one processor to perform the method according to at least the paragraphs above.

Further, in accordance with the exemplary embodiments of the invention, there is an apparatus comprising means for collecting metrics from one or more network devices of the wireless communication network, and means for using the collected metrics to enable one of establishment and modification of a Bearer in the wireless communication network to provision a service in accordance with specified characteristics.

The apparatus according to the paragraph above, where the means for collecting comprises an interface to the wireless communication network, where the means for using the collected metrics to enable one of establishment and modification of the Bearer comprises an interface to a service entity, and at least one computer readable memory embodying at least one computer program code, the at least one computer program code executed by at least one processor.

In addition, in accordance with the exemplary embodiments of the invention as described in the paragraphs above, the collecting the metrics comprises communicating with the one or more network devices using interfaces comprising at least one of an Rx, SLh, SLg, a GTP-u and a Diameter over SCTP interface.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method, comprising:
collecting metrics from one or more network devices of the wireless communication network; and
using the collected metrics to enable one of establishment and modification of a Bearer in the wireless communication network to provision a service in accordance with specified characteristics.

2. The method according to claim 1, where using the collected metrics to enable the one of establishment and modification of the Bearer comprises providing an indication of the collected metrics to a service entity to provision the service using the Bearer to a user equipment associated with the wireless communication network.

3. The method according to claim 2, where the specified characteristics are a specified characteristics of at least one of the service entity, the at least one user equipment, and the wireless communication network.

4. The method according to claim 2, where the collecting metrics comprises collecting from the user equipment information regarding at least one of a location and a velocity of the user equipment.

5. The method according to claim 2, where the indication of the collected metrics is provided to the service entity, at least in part, over a diameter interface using a stream control transmission protocol.

6. The method according to claim 2, where the indication of the collected metrics comprises at least one of the collected metrics and an interpretation of the collected metrics.

7. The method according claim 2, where the indication of the collected metrics provided to the service entity is determined based on at least one of a content type of the service and a policy associated with at least one of the service entity and the user equipment.

8. The method according to claim 1, where the collecting metrics comprises collect the metrics over a diameter interface from at least one of a policy control function, a charging rules function, and a mobility management entity of the wireless communication network.

9. The method according to claim 1, where the collecting metrics comprises collecting metrics associated with at least one of a cell and sector of the wireless communication network collected from a base station of the wireless communication network.

10. The method according to claim 1, where the modification of a Bearer in the wireless communication network is performed based on a request from a service entity located outside the wireless communication network.

11. An apparatus comprising:
at least one processor; and
at least one memory including computer program code, where the at least one memory and the computer program code are configured, with the at least one processor, to cause the apparatus to at least:
collect, based on specified characteristics regarding a provision of a service in a wireless communication network, metrics from one or more network devices of the wireless communication network; and
use the collected metrics to enable one of establishment and modification of a Bearer in the wireless communication network to provision the service in accordance with the specified characteristics.

12. The apparatus according to claim 11, where using the collected metrics to enable the one of establishment and modification of the Bearer comprises the at least one memory including the computer program code is configured, with the at least one processor, to cause the apparatus to provide an indication of the collected metrics to a service entity to provision the service using the Bearer to a user equipment associated with the wireless communication network.

13. The apparatus according to claim 12, where the specified characteristic is a specified characteristic of at least one of the service entity, the at least one user equipment, and the wireless communication network.

14. The apparatus according to claim 12, where the collecting metrics comprises the at least one memory including the computer program code is configured, with the at least one processor, to cause the apparatus to collect from the user equipment information regarding at least one of a location and a velocity of the user equipment.

15. The apparatus according to claim 12, where the indication of the collected metrics is provided to the service entity, at least in part, over a diameter interface using a stream control transmission protocol.

16. The apparatus according to claim 12, where the indication of the collected metrics provided to the service entity comprises at least one of the collected metrics and an interpretation of the collected metrics.

17. The apparatus according to claim 12, where the indication of the collected metrics provided to the service entity is determined based on at least one of a content type of the service and a policy associated with at least one of the service entity and the user equipment.

18. The apparatus according to claim 11, where the collecting metrics comprises the at least one memory including the computer program code is configured, with the at least one processor, to cause the apparatus to collect the metrics over a diameter interface from at least one of a policy control function, a charging rules function, and a mobility management entity of the wireless communication network.

19. The apparatus according to claim 11, where the collecting metrics comprises collecting metrics associated with at least one of a cell and sector of the wireless communication network from a base station of the wireless communication network.

20. The apparatus according to claim 11, where the modification of a Bearer in the wireless communication network is performed based on a request from a service entity located outside the wireless communication network.
